(19) United States
(12) Patent Application Publication
(10) Pub. No.: US 2018/0214879 A1
(43) Pub. Date: Aug. 2, 2018

(54) NUCLEIC ACID AMPLIFICATION

(71) Applicants: Nelson Nazareth, Upper Dean (GB); David Edge, Warlingham (GB); Adam Tyler, Burton Latimer (GB)

(72) Inventors: Nelson Nazareth, Upper Dean (GB); David Edge, Warlingham (GB); Adam Tyler, Burton Latimer (GB)

(21) Appl. No.: 15/932,653

(22) PCT Filed: Sep. 30, 2016
(86) PCT No.: PCT/GB2016/000178

§ 371 Date: Apr. 2, 2018

(30) Foreign Application Priority Data
Oct. 1, 2015 (GB) 1517372.7
Jan. 20, 2016 (GB) 1601061.3
Aug. 12, 2016 (GB) 1613911.5

(51) Int. Cl. B01L 7/00; B01L 3/00

(52) U.S. Cl. CPC B01L 7/52; B01L 3/508; B01L 2300/12; B01L 2300/042; B01L 2300/0851; B01L 2200/12; B01L 2200/04; B01L 2300/18; B01L 2300/0672

(57) ABSTRACT

A nucleic acid amplification (NAA) reaction vessel includes two opposing major walls a minor wall system, having two minor walls which are attached to the major walls, define a reaction chamber having a base, with the major and minor walls being formed of a thermally conductive material. An inlet port permits the introduction of fluid into the reaction vessel, and a cap is arranged for sealing the inlet port. A light transmissive window is located at the base of the vessel reaction chamber. The vessel has a capacity greater than 100 microlitres. Process and apparatus employing the reaction vessel are also described.

### FIELD OF THE INVENTION

The present invention relates to apparatus and process for amplifying nucleic acid targets. It is particularly concerned with Nucleic Acid Amplification (NAA) including Polymerase Chain Reaction (PCR), RT-QPCR and QPCR as set out in European Patent Application EP2585581, and most particularly with direct amplification from crude biological samples such as blood and sputum.

Background to the Invention European Patent Application EP 2585581 describes a method for cell disruption performed by multiple cycles of freezing and thawing a sample such that ice crystals physically disrupt cell membranes or viral capsids and subsequent thawing induces massive osmotic shock, releasing cellular contents. In a preferred embodiment a direct detection of the released nucleic acids was described by combining in a single closed tube the freezing and thawing process an amplification such as the real-time PCR process. A limitation of that specification is the amount of the sample that could be added directly into the amplification based detection step. There are circumstances where the quantity of a suspected pathogen is so minute that PCR may be rendered inaccurate as a means of detection or at least take longer than might in certain circumstances be desirable. An example may be the detection of bacterial sepsis, where the number of bacteria can be as low as 10 per ml of blood, or similarly low level viral disease such as HIV. The sample matrix is itself a complication because adding more sample will additionally increase the percentage of inhibitors of the process, for example the iron in blood is an inhibitor of PCR and as such it is not possible to increase the final percentage of blood in order to improve sensitivity.

Known NAA is usually performed using a reaction vessel of microtitre capacity, that is between about 20 μl and 50 μl, the vessel being tubular and no more than 2 cm long with a reaction chamber of the order of 4 mm outside diameter.

Thus, as will be appreciated from the above there is a requirement for diagnostic tests which are both sensitive and yet susceptible of completion in a very short time, for example in the face of an emerging disease outbreak where in-field screening could save many lives. Yet in some matrices, for example sputum and urine, the actual quantity of a target can be below the limit of detection for direct detection, where the crude sample is added directly to the reaction vessel, in assays known hitherto. Again, some diseases such as hemorrhagic diseases in blood are detectable but the aetiology means that there is an early phase, characterized by very low titres, while rapid detection is vital. Moreover, the detection of a pathogen in a screening operation, when the signs and symptoms of a disease have not presented because the pathogen has not yet greatly replicated, is highly desirable.

It may be thought that the successful performance of PCR in such circumstances would be simply a matter of increasing the size of the reaction vessel. However rapid and accurately consistent input and extraction of heat to and from a sample in a large vessel is particularly difficult to achieve in itself. Yet the important rapid detection of pathogen nucleic acids, both RNA and DNA, implies rapid thermal cycling, minimizing transitions times and ensuring thermal uniformity within the contents of the sample being analysed

European Patent Specification 2308995 (Cepheid) describes a reaction vessel having a chamber of up to 100 microlitres and comprising two major opposing walls, a plurality of minor walls joining the major walls so as to form a reaction chamber, a port for introducing fluid into the chamber, with two of the minor walls being light transmissive to provide optical windows and the ratio of thermal conductance of the major walls to that of the minor walls being at least 2:1. In various ways this vessel is not ideal for use in fulfilling all of the sometimes competing requirements for rapid nucleic acid amplification and detection by the means described here being neither thermally conductive enough nor large enough volume, being restricted to 25 microlitres in the co mmercially available embodiment.

European Patent Specification 2333520 (Cepheid) describes a heat exchanging, optically interrogated chemical reaction assembly comprising a vessel having a reaction chamber, the reaction chamber being defined by two opposing major walls and a plurality of rigid minor walls, a port for introducing fluid into the chamber and a channel connecting the port to the chamber, and a plug insertable into the channel to increase pressure in the chamber, the assembly also comprising at least one heating surface.

The apparatus and vessel covered in the Cepheid disclosure are inadequate to perform rapid amplification and detection over the whole gamut of occurring situations. In particular there are important processes for detecting pathogens directly from crude samples such as blood, sputum and swabs which are not disclosed and which could not be performed with the Cepheid or any other known apparatus.

### SUMMARY OF THE INVENTION

The requirement on the one hand for sufficient sample volume to have a dilution effect, for example a minimum of a one in ten dilution is necessary to reduce concentration from a molar to millimolar range, and on the other a speed sufficient to perform rapid freezing and boiling places certain quite exacting criteria on the reaction vessel and cycling apparatus. The authors have found by experimentation that in order to detect a viral load of 100,000 virus particles per ml of whole blood, a minimum of five microliters whole blood sample are necessary while to detect 10,000 viruses twenty microliters is required. The viral load in a Zika infected patient rises to over 100,000 viruses per ml but by the eighth day drops to below 10,000. Thus any assay designed to detect this exemplar virus must be able to detect to these low levels. Blood is an inhibitor of PCR: for non-modified PCR enzymes a maximum percentage of blood that can be tolerated is in the region of 2% while for modified enzymes (for example US201325230) the maximum percentage can be as high as 12%. It will be clear that in order to dilute 5-20 μl to as low as 2-12% blood that the final reaction volume must be in the 250 μl to 750 μl range. As a result the volume to be thermal cycled can be 15 times as much as a standard 50 μl reaction.

The present invention provides a system capable of the detection of multiple nucleic acid species, both RNA and DNA, in a rapid fashion directly from sample over 200 μl in volume, that is, including a blood sample taken directly from a finger in customary fashion. The process and apparatus builds on earlier background work (EP2585581) in the fields of rapid PCR, direct freeze/thaw extraction and combined amplification in a single tube and latterly a random access instrument for the point of care performance of assays.

It provides a large consumable reaction vessel having high thermal conductivity, reduced thermal mass, maximum surface area to volume area and thin outer walls; further it describes a heating/cooling arrangement based on a heat removal module (U.S. Pat. No. 8,597,397) and a pair of Peltier devices such that the time to detection is minimised and the system is constructed to survive many repeated cycles of freezing/thawing.

The vessel may be made by injection molding polypropylene loaded minimally with 40% carbon in the form of graphite and powder or other suitable fillers such as boron nitride. In the preferred embodiment the loading is 65%.

It further provides a process wherein either the sample is added directly to the reaction vessel containing the amplification reagents or the sample is subjected to a two-step process wherein a freeze/thaw step is completed prior to the subsequent addition of the amplification reagents. A benefit of the two step approach is the ability to make thermal excursions that would denature enzymes in the amplification reagents, for example long boiling steps, or to use chemicals to enhance cell lysis that would be at too high concentration in a one step process but are diluted out by the addition of the reagents in a two-step process. For example placing the crude sample, such as blood, in a chemical that in the blood alone is a 50/50 ratio which would be incompatible with the amplification process. However, the subsequent addition of the amplification reagents is sufficient to dilute the concentration in the reaction to the point of compatibility.

According to a first aspect of the present invention a nucleic acid amplification (NAA) reaction vessel comprises:

two opposing major walls;

a minor wall system attaching the major walls and thus defining a reaction chamber having a base, the major and minor walls being formed of a thermally conductive material;

an inlet port permitting the introduction of fluid into the reaction vessel;

a cap arranged for sealing the inlet port;

and a light transmissive window at the base of the vessel reaction chamber, the vessel having a capacity from 100 to 1000 microlitres, preferably 200 -600 microlitres.

According to features of this first aspect of the invention the vessel may have any, some or all of the following elements:
its shape in side elevation is such that the reaction chamber has a base somewhat narrower than the remainder and may even be substantially pointed. Thus the shape may be round or, more likely oval with the major axis vertical, or it may be rhomboid or square. It may be shaped like an opened letter envelope with the apex at the reaction chamber base, or a shield;
the light transmissive window is in the minor wall at the base of the vessel;
there is a second inlet port;
the or each port comprises a channel focused upon the base of the vessel;
a taper in the minor walls, downward from top to bottom. This may be of the order of one to four degrees in total and is arranged to assist in maintaining contiguity between the major walls and heater elements;
a pierceable station, preferably in an upper region of a minor wall, arranged for ready access to transfer vessel contents to an electrophoresis device;
the width of the vessel between the major wall is 2-3 mm, preferably 2.4 mm;
the major walls are 0.2-0.6 mm, preferably 0.4 mm thick, thus making the overall width of the order of 3.2 mm;
the overall dimensions of the vessel are up to 40 mm tall by 33 mm broad;
the vessel is a consumable;
the cap(s) penetrate to the reaction chamber, thus forming a continuous, substantially planar ceiling to the chamber, to assist in ensuring that the reactants remain within the chamber, including minimizing condensation;
the vessel may be manufactured in a two shot molding process, whereby the transparent plastic window has the rest of the vessel molded thereover, the transparent window being polypropylene and the remainder being formed of a highly loaded thermally conductive compound such as polypropylene loaded with 25-70% carbon, preferably 40% to 65%. Other transparent materials could be employed but polypropylene is particularly suitable for integration with the remaining vessel material.

The value of the vessel having effectively a reaction chamber which tapers down, either by being triangular (preferably), oval or circular is that the vessel is thus capable of being used with very small samples, for example of blood, sputum or swab, as well as much larger samples. Moreover, and importantly, it is then capable of being used in a two stage process, which is why the preferred vessel has two inlet ports, which may be labelled respectively. This assists in avoiding spillage of sample in a two stage process, which spillage could be dangerous.

To be somewhat more precise about the dimensions of the vessel:
in the case of a rectangular rhomboid, the sides may be of the order of 24 mm;
in the case of being rectangular, of a height of 29 mm to 40 mm and a breadth of 24 mm to 33 mm;
in the case of being rectangular with a triangular or semicircular base, for example shield shaped, a height of the order of 35 mm, a breadth of the order of 33 mm and a base projection of the order of 6 mm.

According to a second aspect of the invention the reaction vessel is constructed by injection molding a clear plastic optical window and then overmolding the body of the reaction vessel in a two-part process, molding the cap(s) and funnel member on a single sprue, the vessel body being formed from polypropylene loaded with carbon. A preferred loading is 65% of carbon. A suitable graphite loaded polypropylene is that supplied by LATI of Italy under reference LATICONTHER 52/11 GR/70 NAT 8826F1.

According to a third aspect of the invention there is provided a nucleic acid amplification reaction apparatus constructed to receive a reaction vessel according to the first aspect of the invention; the apparatus comprising:

at least one reaction vessel receiving station;

two heater guard plates, one to be each side of the vessel and contiguous with the major walls thereof;

a Peltier cell having a working face contiguous with each heater guard plate on the face of the guard plate destined to be remote from the reaction vessel, the Peltier cell having also a base face; and

a reference temperature unit contiguous with the base face of each Peltier cell.

The function of the guard plates is to locate and mount the Peltier cells and retain them in position, as well as to protect them from repeated insertion and removal of vessels. Moreover, the guard plates can contain a recess at their working faces whereby the reaction vessels are more or less completely encapsulated, except for optics access. This goes with making the vessels with the same thermally conductive materials, that is to say major and minor walls, substantially throughout except where the (transparent) sections are required for optical access. Thus the guard plates may be recessed on both sides, that is to say that they preferably have edge walls within which the Peltier cells nestle

According to features of this third aspect of the invention the apparatus may have a longitudinal clamp and incorporate elastic pads, e.g. rubber O-rings to accommodate expansion and contraction of the Peltier cells. It may also comprise:
a retainer arranged for urging the reaction vessel within its station in the apparatus, thus to maintain contiguity between the vessel exterior walls and the heater guard plates; The retainer may be an overhead device arranged to bear on the vessel caps, thus ensuring they too remain in place.
a temperature sensor or thermistor associated with each station, preferably attached to each heater guard;
an optical array arranged for exciting reaction vessel contents through the vessel light transmissive regions and for receiving light emitted from the vessel contents.

Where the apparatus comprises a bank of for example four reaction stations a device, such as a solenoid operated shutter, may be incorporated to prevent the intrusion into the spectrophotometer of extraneous light from another empty station or from the environment. An overhead retainer may be incorporated to urge the tapered vessel downwards into the apparatus.

The reference temperature unit may comprise a thermally conductive, preferably metal, even sintered metal case having fluid flow ducts formed therethrough, which ducts may be connected in a circuit comprising also a fluid pump, to a heat exchanger arranged to keep fluid, usually water, at a constant temperature. In an apparatus where the associated process includes freezing and thawing the sample, immediately prior to conducting NAA, the reference temperature is such that the ΔT (Delta T) of the Peltier is able to encompass both freezing and boiling. Typically this may be 18 to 26° C. The ducts may incorporate a chicane system to maximize heat transfer and ensure mixing of the temperature control medium such that they are at a substantially even temperature from entrance to exit from the unit. The temperature reference unit may incorporate crenellations to nestle the base face of the Peltier cell.

It will be appreciated that in the context of the present invention the Peltier cell will normally be arranged to be operated by reversible direct current whereby the working face can at one instance be a heater and at another a cooler. The Peltier cells and the reaction vessel major walls may be substantially coterminous but to ensure even heat input and loss it may be preferred that the Peltier cells overlap the vessel sides, with the Peltier cell being usually square.

A preferred optical array is a reflectance probe arrangement employing two core optical fibres, one core arranged to transmit the excitation light into the reaction chamber from a laser diode or LED or other high powered light source and the other emerging light to a spectrophotometer which may be incorporated in the apparatus. A shutter may be incorporated between the vessel and the fibre to minimize optical interference between one station and another when a station is not being employed.

It will be appreciated that a preferred arrangement for a multi-station apparatus is for the apparatus to be arranged for individual station operation in a random access fashion. This being the case an arrangement of solenoid switches may be built into the optic fibre array such that the light from any one reaction vessel can be imaged on the shared spectrophotometer without interference from any other of the vessels or indeed environmental light in the case of one or more reaction stations being empty.

According to a fourth aspect of the invention a process for the amplification and detection of nucleic acid comprises:
taking a sample, for example of blood via a finger prick or of sputum or a swab such as a mouth swab;
placing the sample in the reaction vessel and adding a volume of freezable liquid such as water or one chosen to increase the efficiency of cell lysis, for example solutions containing quaternary ammonium salts, chaotropic salts, surfactants or acid/bases;
cyclically freezing (first) then thawing the vessel contents to lyse the cells;
adding NAA reagents and fluorescently labelled probes;
carrying out NAA on the reaction vessel contents;
optically interrogating the reaction vessel contents during the PCR.

According to important features of this fourth aspect of the invention:
reverse transcription is optionally performed before the PCR step, thus to convert RNA to DNA;
the freeze/thaw temperatures may be of the order of -5 and +20° C. respectively;
there may be a boiling stage following the freeze/thaw stage, with a temperature of the order of 88 to 98° C.; Optionally this temperature excursion will be to just above the melting point of the primers/probes;
the probes may be labelled with dyes known in the art such as fluorescein, HEX and TET.
the NAA may be PCR or isothermal amplification methods and the reagents may comprise lyophilized reagents which will be activated upon contact with liquid vessel;

There are two particularly valuable features to carrying out this process with a preferred embodiment of the invention. One is that the insertion of the sample into a vessel in one of its two ports, whilst the other is closed, minimizes the possibility of contamination when the reagents are put in the second port. The process can be performed then in its entirety in the one vessel without risking the denaturing of the reagents during the freeze/thaw part of the process. The second is that one may detect a multiplicity of pathogens by subjecting the vessel contents to electrophoresis.

For this purpose a pierce station may be incorporated in a vessel upper minor wall to facilitate the transfer of vessel contents to an electrophoresis device.

One particular example of the value of the present invention is in the detection of Ebola from whole human blood. With apparatus according to the present invention it is possible to perform direct RTQPCR and detect as few as 6 filovirus (ZEBOV) particles in a crude blood sample. This means that infected patients showing samples can be effectively screened and triaged with the assay. Other pathogens which may be identified in the process of the invention include Lassa, Marburg, Zika, Chikungunya, Dengue, Yellow fever, Rickettsia, HIV, Crimea Congo fever, Blue tongue, and PPRV, all of which are blood borne.

According to a fifth aspect of the invention, a disposable reaction vessel may be packaged in a kit, the package containing the reaction vessel, a container of extraction buffer, water to resuspend the reagents and a container of lyophilized reagents. Optionally there may also be a finger pricking device and a capillary such as a microsafe device for taking blood. It will be appreciated that apparatus according to the invention can readily be constructed for field operation, including in the tropics.

The invention as a whole affords very considerable advantages. A large reaction vessel as herein described allows the examination of a reasonable quantity of blood sample whilst minimizing the concentration of that blood in the reaction, given that the blood also inhibits PCR. Also, a larger vessel, when used in the two step process the invention provides (freeze/thaw then PCR), allows adding extraction buffer at high concentration in the first step and then diluting it out via the additional PCR reagents in the second step.

In a known apparatus a 62.5 μl assay has 5 μl whole blood component, this being 8% volume by volume. In principle this assay can detect 10⁴ targets per ml so that doubling the amount of blood should double the sensitivity. However, this ignores the inhibitory effect of blood on both amplification and fluorescent signals. With apparatus and process according to the present invention it is possible to show that a larger reaction with the same amount of target added and hence reducing the final blood concentration may actually be ten times more sensitive even though the amount of target remains the same.

By virtue of the invention therefore, there is provided a high capacity reaction vessel with high thermal conductivity and a high aspect ratio that is capable of performing rapid freezing/thawing. This allows a much larger reaction to be made possible than in microtitre tubes hitherto particularly as an identical amount of crude sample can be diluted to a lower final percentage in the reaction. This dilution effect can render possible the use of a wider range of crude sample types than hitherto. Additionally, the single step process of the past has had to be limited to the use of reagents compatible with the downstream process. For examples one couldn't add any adjuncts such as chaotropes to assist the cell lysis process because they would themselves inhibit the reaction if present at concentrations sufficient to have any measurable improvement on the lysis. Similar examples would be extremes of pH or the addition of solvents or detergents which may again assist in the lysis of the cell but have an overall effect of reducing sensitivity by reducing the efficiency of the NAA reaction. A larger volume reaction vessel according to the invention makes possible a 2 step process still contained within a single vessel. The process can then for example have a very low or high pH in the first step and then, due to the greater space above that of the first step reaction have this buffered out ready for the second step. Likewise, the first step could include thermal excursions that would denature enzymes which might have been included ab initio to be ready for the second step. Therefore a 2 step method performed entirely within a larger capacity vessel of the invention actually increases the sensitivity over and above existing lower volume methods providing benefits specific to direct detection methodology. Nevertheless the possibility also exists of separating the RT-QPCR process between the two steps, for example performing reverse transcription subsequent to the freeze/thaw with the reagents being present with the blood sample, then adding a second larger volume of PCR reagent. This has the benefit that the buffer for each process can be optimized to the correct enzymatic reaction.

### PARTICULAR DESCRIPTION

Embodiments of the invention will now be described by way of example with reference to the accompanying drawings, of which:

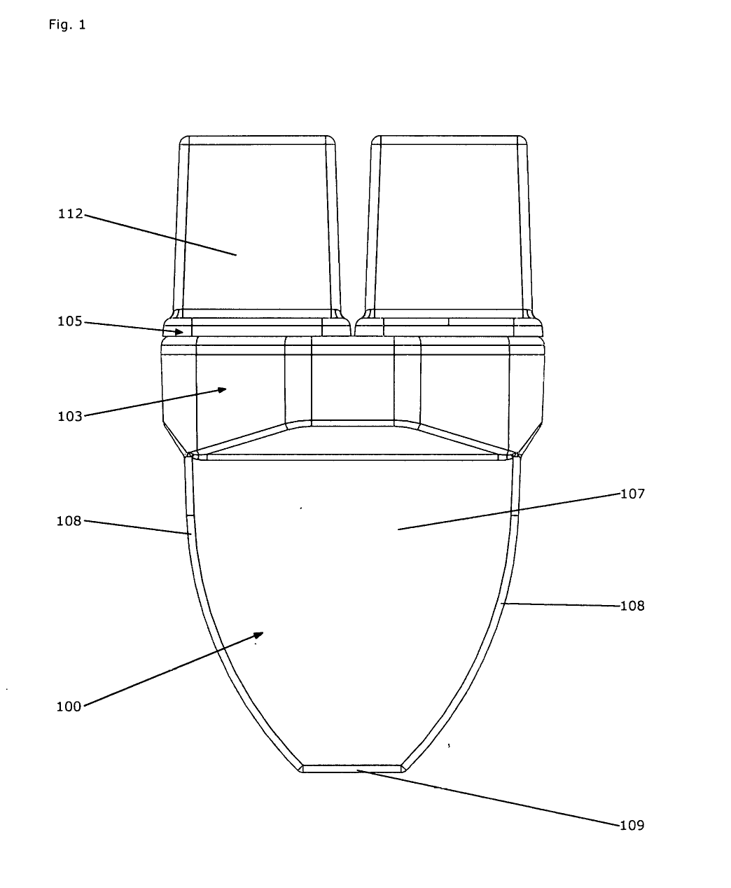

FIG. 1 is a face elevation of a reaction vessel;

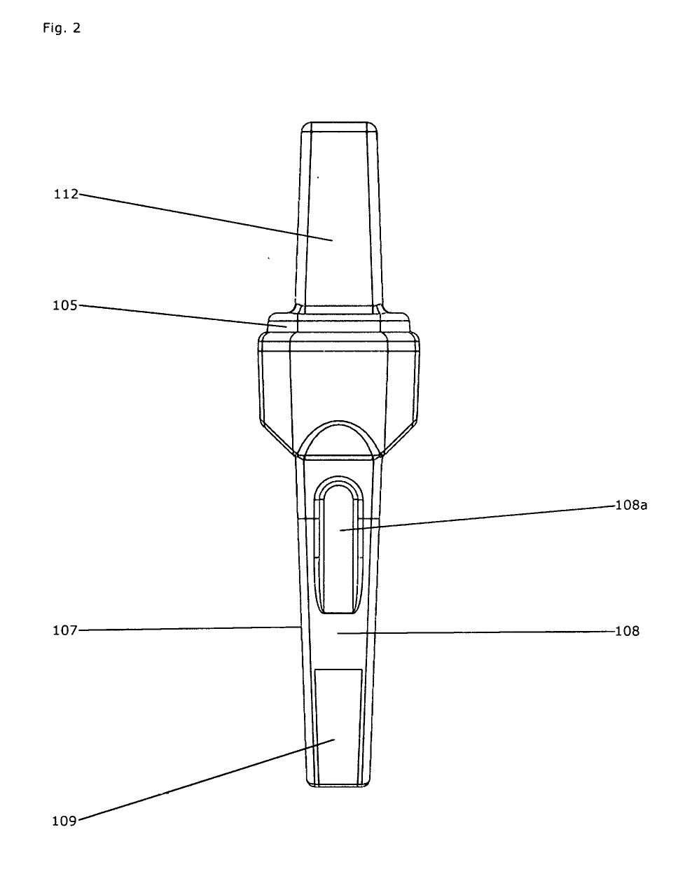

FIG. 2 is a side elevation of the reaction vessel of FIG. 1;

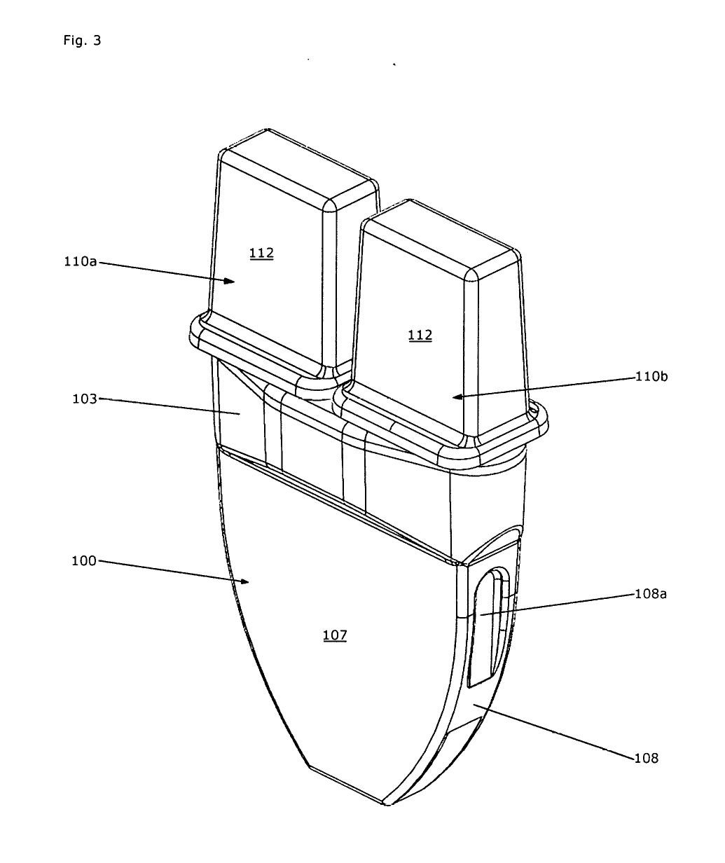

FIG. 3 is an isometric view of the reaction vessel of FIG. 1

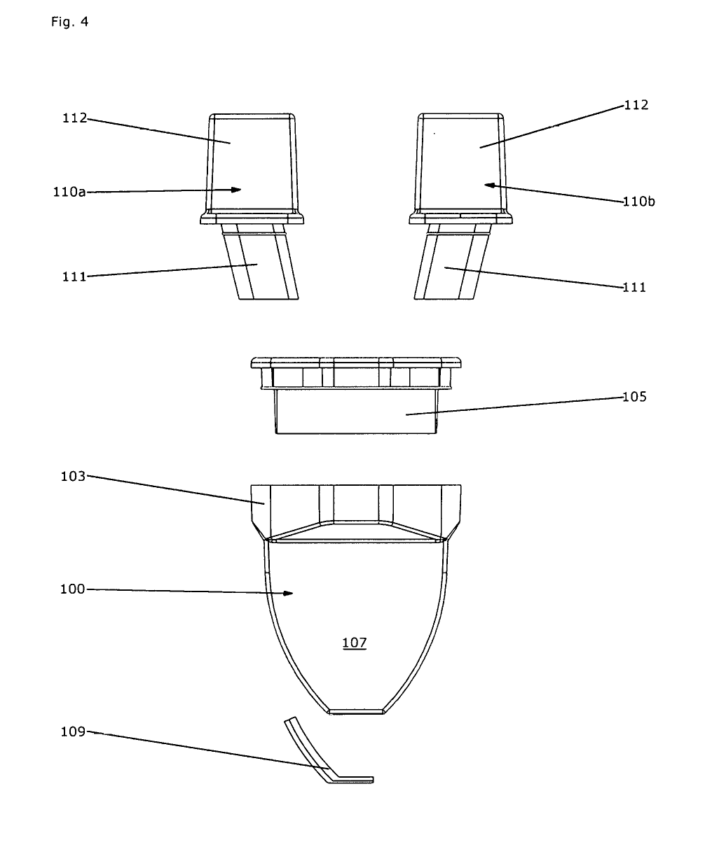

FIG. 4 is an exploded view of the parts of the vessel of FIG. 1;

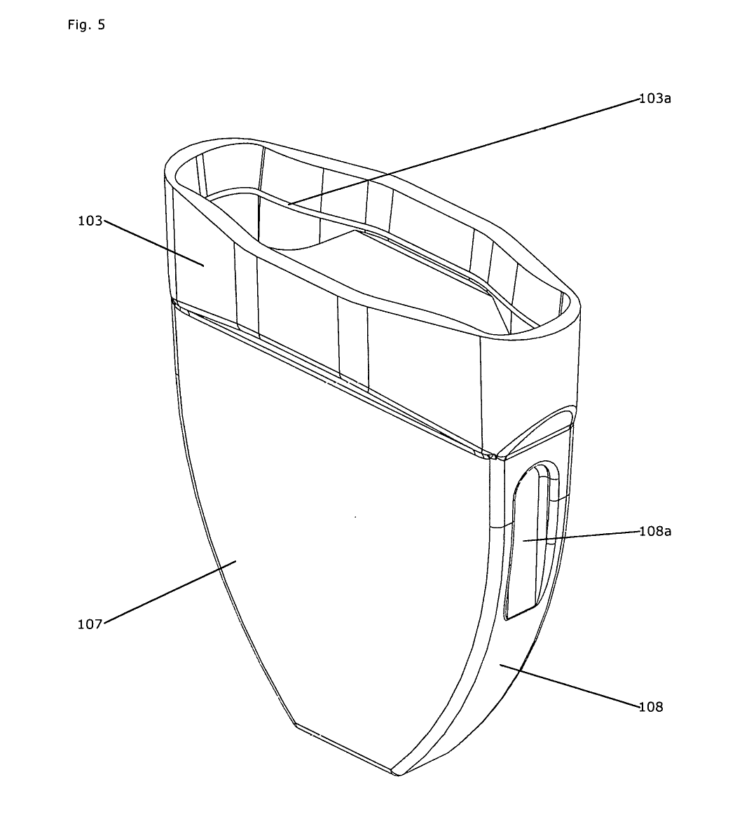

FIG. 5 is an isometric view of the reaction chamber part of the vessel of FIG. 1;

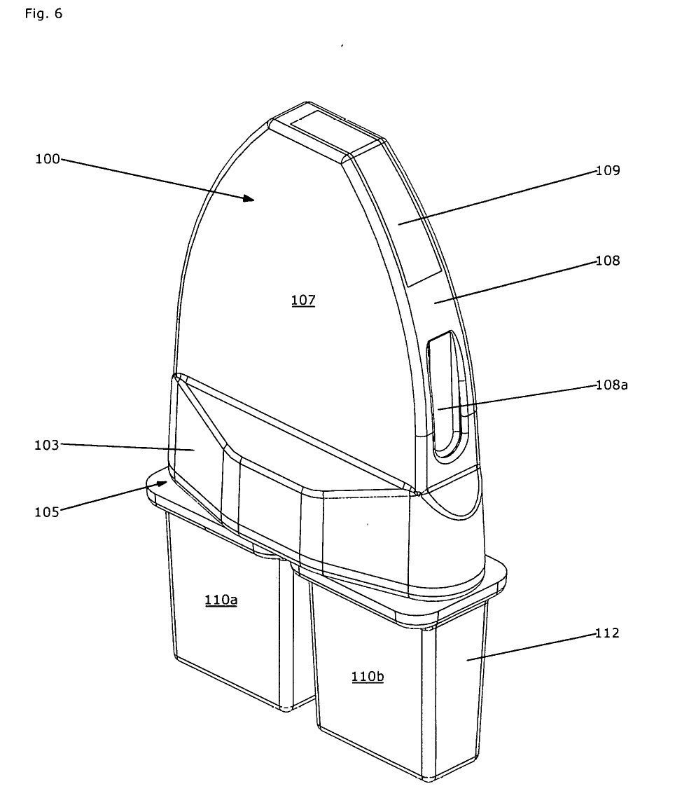

FIG. 6 is an inverted isometric view of the reaction chamber portion of the vessel of FIG. 1;

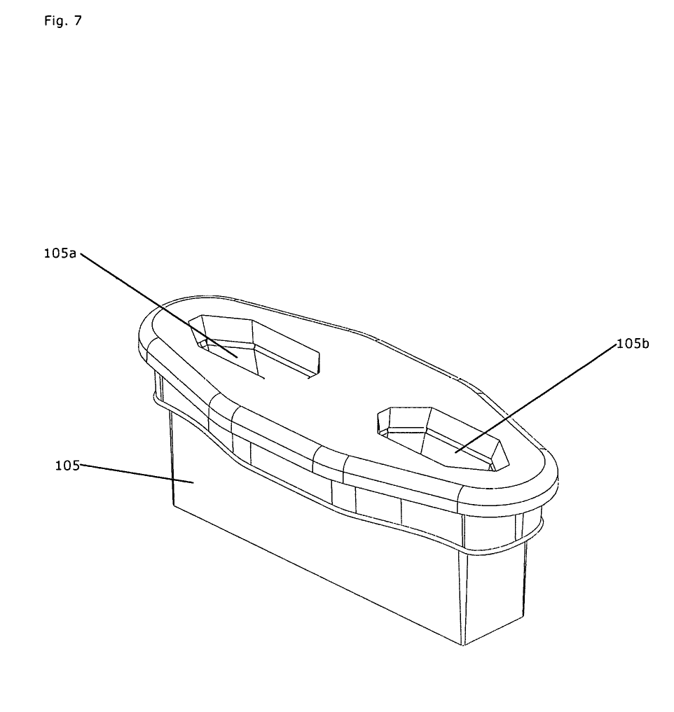

FIG. 7 is an isometric view of the funnel portion of the vessel of FIG. 1;

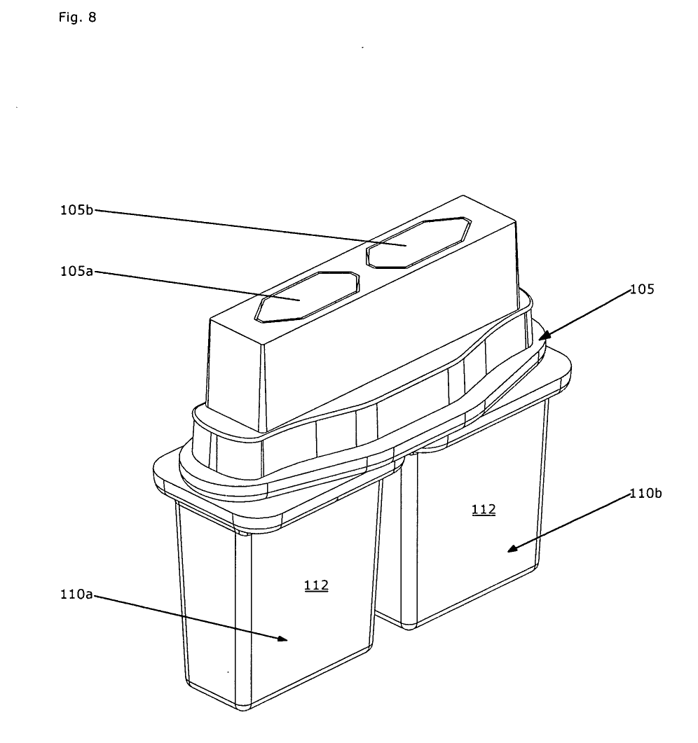

FIG. 8 is an inverted isometric view of the funnel portion of the vessel of FIG. 1;

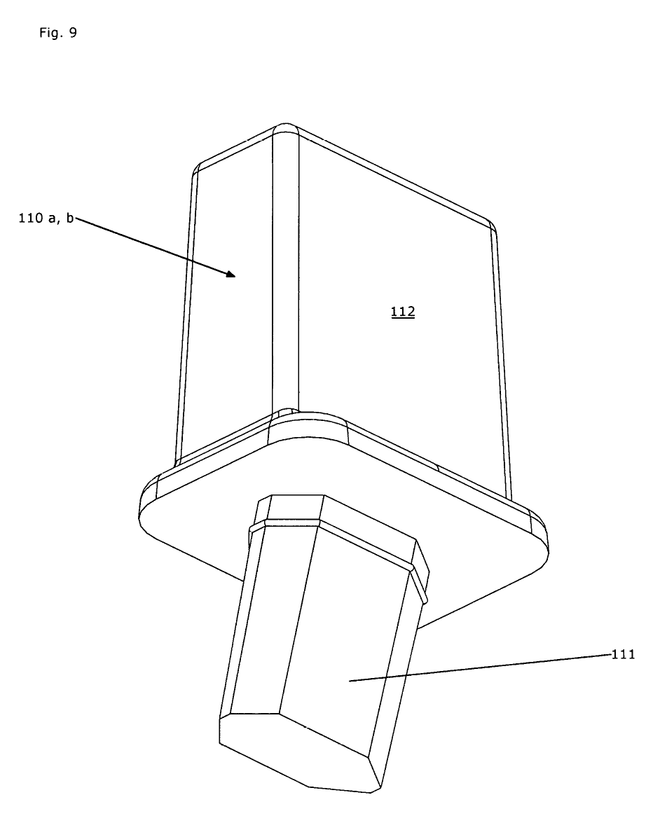

FIG. 9 is an isometric view of a cap to the vessel of FIG. 1;

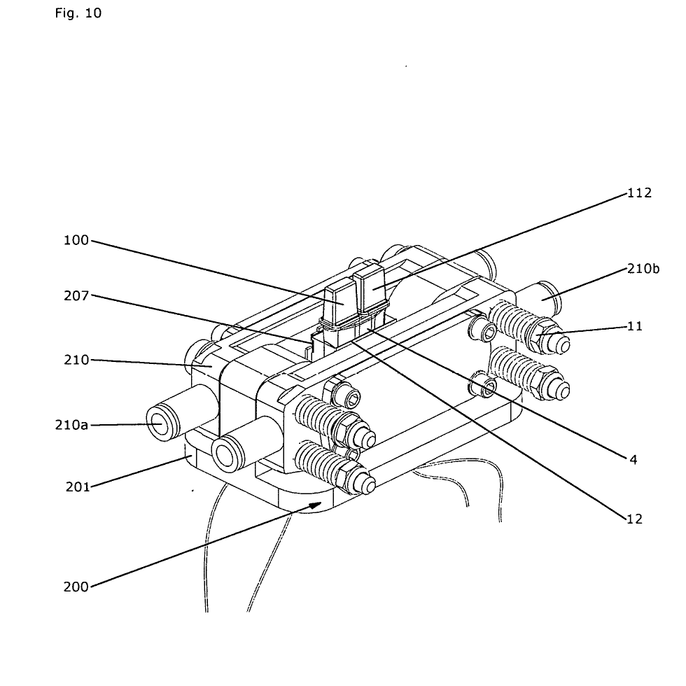

FIG. 10 is an isometric view of a reaction apparatus for the vessel of FIG. 1;

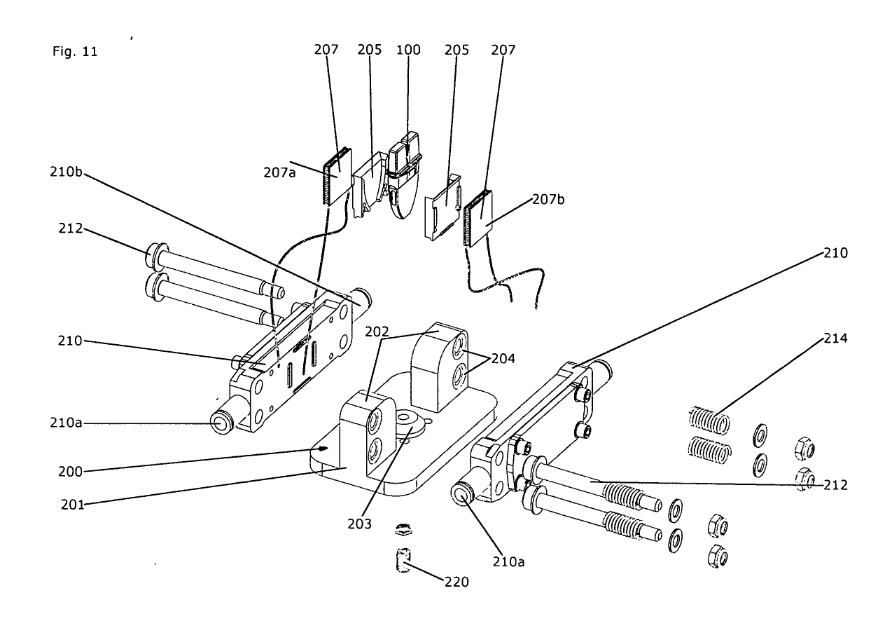

FIG. 11 is an exploded view of the reaction apparatus of FIG. 10;

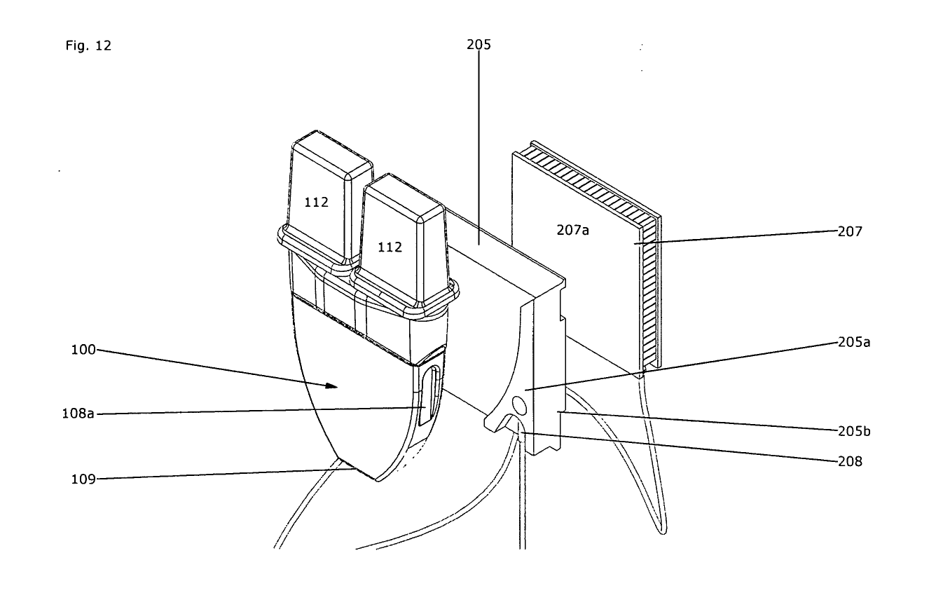

FIG. 12 is an isometric exploded view of the reaction vessel of FIG. 1 with an associated guard plate and Peltier cell;

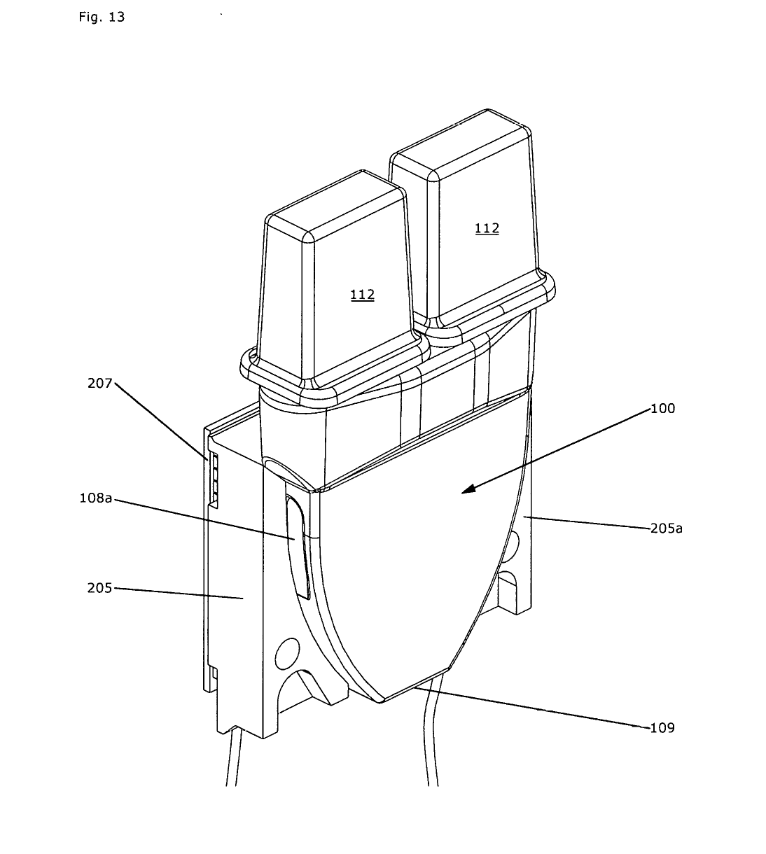

FIG. 13 is an isometric view of the elements of FIG. 12, assembled;

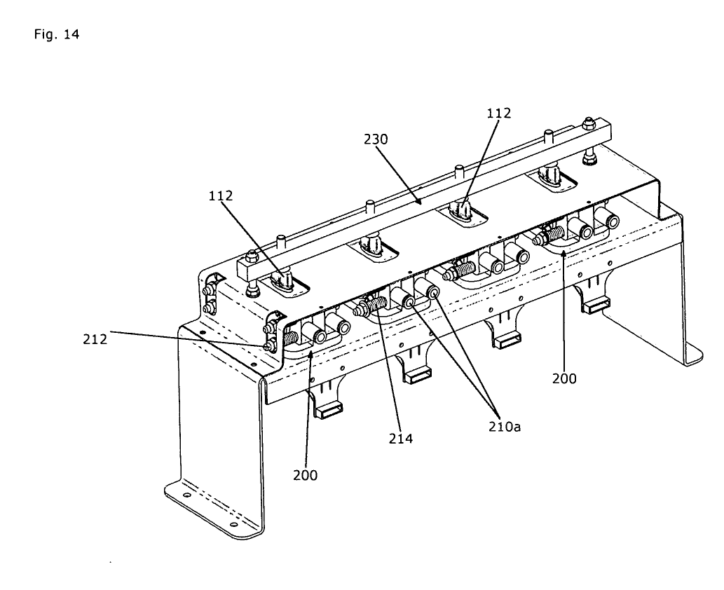

FIG. 14 is a schematic view of a reaction apparatus bank; and

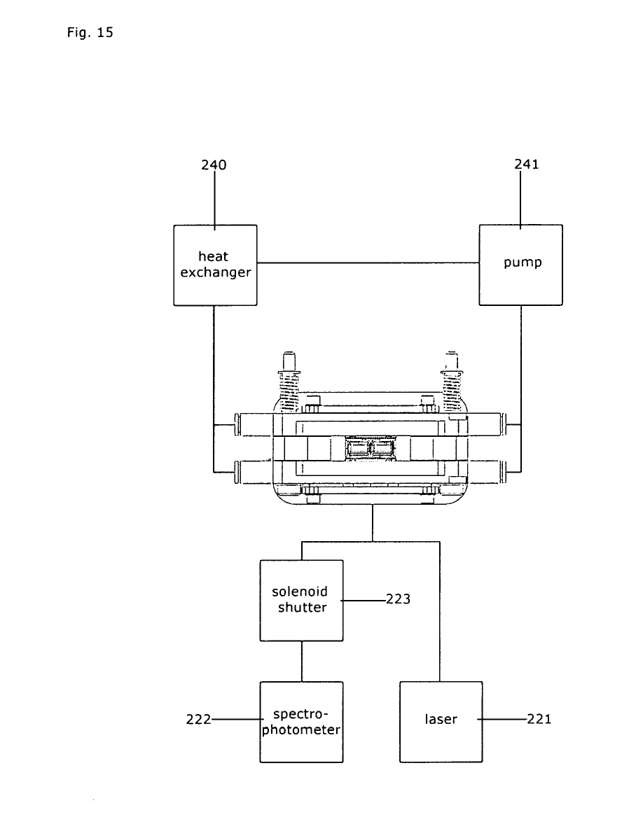

FIG. 15 is a schematic view of a complete reaction apparatus with ancillary facilities.

FIGS. 1 to 7 illustrate a reaction vessel according to the invention, the reaction vessel being substantially shield shaped but with a flat base. The vessel comprises a reaction chamber portion 100, a filler funnel receptacle portion 103 and a filler funnel 105. The reaction chamber portion is constituted by two major walls 107 surrounded at their sides by minor walls 108 and at the base by a transparent window 109. The filler funnel 105 comprises two entry ports 105a and 105b , both focused on the base of the reaction chamber 109. The receptacle portion 103 is formed integral with the reaction chamber portion 100 and is constructed as a stiffener thereto and to receive sealably a filler funnel 105 via a lip 103a.

Toward the top of a minor wall 108 is a pierceable access station 108a . This is there to permit penetration by a hypodermic device, to withdraw reaction chamber content and transfer same to an electrophoresis apparatus.

Two caps 110a and 110b have sealing members 111 and handle tags 112. The sealing members 110 are shaped as tight push fits in the funnels105a and 105b and are closed at their bases (as shown in FIG. 9) so as to form a substantially continuous ceiling to the reaction chamber 107 when fitted.

The handle tags 112 of the caps (110a ,110b )) are large enough to be manipulated by those wearing protective gloves and the distal portions 111 are closed at the base of the cap to provide single flat surface that forms the ceiling to the reaction chamber 107. This flat section lies within the heated and cooled portion and as such prevents condensation forming. The caps may be colour coded and/or numbered such that it is clear to the operator which cap must be opened for each of the two steps of the process.

The vessel minor walls (108) have a taper angle of 4 degrees in order to ensure a good thermal contact with the thermal cycling apparatus when downward pressure is exerted. The thickness of the major walls (107) is 0.4 mm. This ensures rapid thermal transfer to enable freezing/boiling in the shortest possible time. The dimensions of the reaction chamber are 23 mm tall and 20 mm in breadth, the distance between the internal walls is 3.6 mm and as such the external thickness of the vessel is 4.4 mm when the two wall thicknesses are taken into account. The internal volume of the reaction chamber (100) is 600 μl. The completed vessel is constructed by taking a reaction vessel chamber (100) and clicking into place a cap holder insert (105) by means of a retaining feature (103a ) located on the inside receptacle portion 103

The reaction vessel 100 is constructed by injection molding in a two-part process with the caps (110) and insert (105) being on a single sprue and the vessel itself (100) being made by molding a clear plastic optical window (109) and then overmolding the remainder of the reaction vessel. The vessel is made from polypropylene loaded with carbon to 65% as a mixture of carbon black and graphite in order to provide good thermal conductivity.

It will be appreciated that the reaction vessel is a consumable, that is it is intended for disposal after a single use.

FIGS. 10 to 13 illustrate the apparatus 200 used to thermally cycle the reaction vessel.

The apparatus comprises a mount having a base 201, two supports 202 and an optics unit access aperture 203. In each support 202 are clamp holder holes 204. A space between the supports 202 is adapted to receive two guard plates 205. The guard plates 205 are constructed with flange walls 205a adapted between them to surround snugly the reaction chamber 100 of a reaction vessel, and also with flange walls 205b projecting away from the flange walls 205a and forming a station within which is attached, permanently or seperably, a Peltier cell 207, one each side of the reaction vessel. Each Peltier cell 207 has a working face 207a destined to associate with the reaction vessel and a base face 207b distal from the working face 207a . Associated with each base face 207b is a heat reference unit 210. The heat reference unit 210 has entry and exit ports 210a and 210b between which is a serpentine or chicaned fluid duct. The heat reference unit 210 also has crenellations 210c to nestle the base face 207b of a Peltier cell 207. A thermal paste is applied to both faces of the Peltier cells 207 to ensure that good thermal contact is made. There is a temperature sensor 208 in a guard plate 205.

The apparatus has clamping means adapted to urge the Peltier cells working faces 207a against the reaction vessel via the guard plate 205 and to urge the heat reference units 210 against the Peltier cell base faces 207b . The clamping means comprise four bolts 212 which pass through the temperature reference units 210 and the holder holes 204 in the supports 202, Two of the holes in the temperature reference units 210 are screw threaded. Springs 214 mountable on the bolts 212 serve to maintain pressure of the temperature reference units 210 on the Peltier cells 207, guard plates 205 and the reaction vessel 100 respectively. The clamping means allows a degree of flexibility such that during heating and cooling the Peltier cells 207 can expand and contract and thus not be degraded.

The optics unit access aperture 203 is adapted for the fitment of a dual core optics glass fibre 220 arranged for reading, through the window 109, the progress of a reaction in a reaction chamber 100. One core provides excitation in the form of a red 635 nmlaser diode 221. The other core collects emitted fluorescence from the vessel and this is delivered to a spectrophotometer 222 collecting all signals in the 650-800 nmspectral range. A solenoid driven shutter 223 serves to ensure that only light from a selected reaction vessel reaches the spectrophotometer 222.

FIGS. 12 and 13 show that the Peltier cells 207 are slightly larger than the reaction chamber and that the heater guard plates 205 wrap around the sides of the vessel such that the whole of the vessel is within the area heated and cooled.

In the four station reaction apparatus illustrated in FIG. 14 there is an overhead retainer 230 arranged for urging the reaction vessels into the apparatus and ensuring their retention and thermal contact in the apparatus during operation.

FIG. 15 illustrates the assembled thermocycler apparatus.

The temperature reference units are connected to a heat exchange unit 240 to supply liquid (water) at a constant temperature via a pump 241. Thus with a current supplied in one direction to the Peltier cell 207 the working face 207a thereof, and hence the guard plate 205 and the reaction chamber, will cool. With a current supplied to the Peltier cell 207 in an opposite direction the working face 207a and hence the guard plate 205 and the reaction chamber will heat.

In a process employing the reaction vessel 100 and the apparatus 200 a crude blood sample is added into the reaction chamber via one of the inlet ports 105a , 105b and either an extraction buffer or in an alternate method reverse transcription reagents are also added. The reaction vessel is then placed into the apparatus 200 and the sample is subjected to multiple cycles of freezing and thawing in order to lyse any viral particles contained within, the preferred temperatures from this freezing step are −5 to −20° C. and the thawing is performed at 20° C. In use the temperature reference units 210 are held at a constant temperature, preferably 20° C., such that via means of the delta T of the Peltier cells 207 it is possible to drive the contents of the reaction to −20° C. regardless of environmental conditions. The temperature reference units 210 contain a fluid path through which temperature controlled fluid is passed, this fluid channel may be serpentine in form to maximize contact time for the fluid.

The vessel described is used in a process to directly detect nucleic acid species from crude samples, a pertinent example being the direct detection of viral RNA from whole human blood taken from fingerprick samples in an epidemic outbreak situation. The process involves the direct addition of the crude sample directly into the reaction vessel, for example via a MicroSafe® device (MicroTec Ltd) or a swab or other vessel and then subjecting the crude sample to a cyclical process of freezing/thawing in order to lyse the viral particles or pathogen cells (EP2585581). The crude sample may be added to a pre-dispensed volume of a medium which will increase the efficiency of the extraction process, such as strong acids/bases, or chaotropic salts as known in the literature. This first step can be optional over the teachings of EP2585581 wherein the freezing/thaw takes place directly in the presence of the amplification reagents, in that case the PCR process reagents. Alternatively, if the reagents are not present for the lysis step it becomes possible to use extraction reagents whose concentration would be inhibitory to PCR or to perform temperature excursions which would damage enzymes critical to amplification processes, for example holds at boiling temperature.

In the single step process a sample of blood, for example 20 μl, is added directly into the reaction vessel in which lyophilised PCR reagents have been previously resuspended. Viral infections such as Ebola are present at titres in excess of 100 viruses per microlitre but other blood borne disease such as HIV will have titres as low as 1 virus per microlitre and as such an advantage of this invention is the ability to add as much as 33 microlitres while still keeping the blood concentration below the 8% upper limit at which PCR still operates with custom engineered polymerases, for example omnitaq U.S. Pat. No. 462,475. Taking Ebola as an example, eight cycles of −10° C. to +20° C. are sufficient to yield 100% lysis. This is most important as it means that identity can be established in a full process lasting no more than 30 minutes.

In a two-step process the first cap is opened and a specified volume of extraction buffer is added. The buffer may be one chosen to improve the lysis efficiency over and above that of freezing in water, or the blood itself alone. The quantity of buffer may be of the order of twice the volume of the crude sample. An example of an extraction buffer would be 2 molar final concentration guanidium chloride. Other examples would be high molarity detergents such as Triton X-100™. The crude sample of 5-30 μl whole blood is taken from the patient via a fingerprick using a microsafe device. The reaction vessel cap is replaced and the vessel is placed into the instrument. The Instrument performs 3-8 cycles of freezing and thawing, followed by an optional short boiling step for difficult targets such as those possessing a cell wall matrix. This is sufficient to release and render amplifiable the nucleic acids from a wide range of organisms and species including viruses, bacteria and fungi. While sample is still in the reaction chamber the second cap is removed and a resuspended mixture of lyophilised PCR reagent is added into the reaction vessel. A typical reagent is Taq polymerase and MMULV in a buffer system optimized for one step RT-QPCR. The cap is replaced, the lid of the instrument re-lowered and 5-10 minute hold is instigated for RNA targets for reverse transcription, but for DNA targets the system transitions straight into a 40-45 cycle real-time PCR process. The contents of the reaction vessel are optically interrogated via the two core optical fibre directed at the base window using the laser diode based excitation and, after signal collection, detection is effected by means of spectrophotometery. The spectrophotometer collates the signal from multiple wavelengths/targets in a single concurrent read and dye deconvolution of the resulting spectra is used to determine which if any of the potential pathogens was present in the initial blood sample.

A brief description of an example of the process is;

1 open first cap and insert in the reaction vessel 15p1 of whole blood suspected of containing a viral pathogen;

2 add 15 μl of extraction buffer, close first cap;

3 freeze/thaw 8 times −10° C. to +20° C.;

4. heat to 80° C. for one second;

5 open second cap

6 add 470 μl of one step RT-QPCR reagents, close second cap;

7 perform 45 cycles QPCR—capture one spectra per amplification cycle;

8 Plot QPCR curve of cycle number against fluorescence value in order to determine crossing threshold and hence determine whether target was present;

9 report to user if viral target was present.

An alternative process involves the performance of a two-step RT-QPCR as opposed to a one step approach. In order to optimize the buffer systems performing a two-step reaction allows the use of a manganese catalysed enzyme in the second step. In this embodiment the reverse transcription reagents which may contain MMULV or AMV enzymes are actually present during the freeze/thaw stage. The benefits of this approach are that the two buffering systems can be optimized to ensure the highest reaction efficiencies for each individual enzyme as opposed to the compromise necessitated in a one-step approach. An example of one embodiment is the addition of EGTA to the first or second buffer to chelate manganese ions or EDTA to chelate magnesium ions. In combination with the dilutionary effect of the larger volume secondary PCRT reaction it is possible to transform an efficient reverse transcription buffer to one suited to QPCR in the second step.

A brief description of an example of this process is;

1 open first cap and insert in the reaction vessel 15p1 of whole blood suspected of containing a viral pathogen;

2 add 85 μl of reverse transcription reagent, close first cap;

3 freeze/thaw 8 times −10° C. to +20° C.;

4. optionally heat to 70° C. for one second;

5 open second cap

6 add 400 μl of QPCR reagents, close second cap;

7 perform 45 cycles QPCR—capture one spectra per amplification cycle;

8 Plot QPCR curve of cycle number against fluorescence value in order to determine crossing threshold and hence determine whether target was present;

9 report to user if viral target was present.

Where it is determined to carry out electrophoresis to identify further pathogens, the reaction vessel may be removed from the NAA apparatus and offered to an electrophoresis apparatus in such a way that fluid flow from the reaction vessel into the latter apparatus is via the pierceable feature 108a . Alternatively the fluid transfer may be effected hyperdermically.

Whether or not electrophoresis is employed, the reaction vessel, being a disposable consumable is, when the process is complete, readily withdrawn via the caps then hygienically disposed of.

A shield shaped NAA reaction vessel as described is particularly advantageous as it enables a first stage of the process to be concentrated in a small volume, and a further stage in a larger volume whilst also provided space for there being two manually manageable inlet ports. Also the inclusion of a tapered form is simple and the quantity of discontinuities minimized. Other reaction vessel shapes are however possible. One could comprise an upper rectangular portion, an isosceles triangular portion depending from the rectangular portion with the angle between the two triangle sides being substantially 90°, the triangular portion being formed for substantially coterminous association with a square Peltier cell at the two faces when the diagonal of the Peltier cell is substantially coterminous with the triangle hypotenuse. A rhomboid or diamond shape is also possible. The vessel clamping and retaining means may be arranged to be quick opening, for example via levers, to shorten process time and arranged such that there is one per reaction position allowing individual random access to each position.

1-55. (canceled)

56. A nucleic acid amplification (NAA) reaction vessel comprising:
two opposing major walls;
a minor wall system integral with the major walls and thus defining a reaction chamber having a base, the major and minor walls being formed of a thermally conductive material;
an inlet port permitting the introduction of fluid into the reaction vessel;
a cap arranged for sealing the inlet port;
a light transmissive window at the base of the minor wall of the vessel reaction chamber; and
the vessel having a capacity of 100 to 1000 microlitres.

57. A vessel as claimed in claim 1 and having a capacity of 200 to 600 microlitres.

58. A vessel as claimed in claim 1 and wherein the reaction chamber base is narrower than the remaining body of the vessel and incorporates the window.

59. A vessel as claimed in claim 1 and which has been formed by moulding the major and minor walls together in a single stage.

60. A vessel as claimed in claim 1 and having a pierce station in a minor wall.

61. A vessel as claimed in claim 1 and wherein the internal width of the vessel between the major walls is 2.5 to 4 mm.

62. A vessel as claimed in claim 1 and wherein the major walls are 0.2 to 0.6 mm thick.

63. A vessel as claimed in claim 1 and wherein the overall dimensions of the vessel are between 20 mm and 25 mm deep by 20 mm to 25 mm broad.

64. A vessel as claimed in claim 1 and wherein the major walls comprise polypropylene containing 50 to 65% carbon by weight.

65. A vessel as claimed in claim 1 and which is packaged in a kit, the kit comprising also a container of extraction buffer, a container of water to resuspend the reagents, and a container of lyophilized reagents.

66. A method of making the vessel claimed in claim 1, comprising:
molding the cap and a funnel member separately;
forming a body of the vessel from polypropylene loaded with carbon;
and, in a separate two-part process:
injection molding the window, in the body of the vessel, from a clear plastic material; and
molding the body of the reaction vessel over the window.

67. A nucleic acid amplification reaction and detection apparatus constructed to receive removably a reaction vessel according to claim 1, the apparatus comprising:
at least one reaction vessel receiving station;
two heater guard plates per station, one to be each side of the vessel and contiguous with the major walls thereof;
a Peltier cell having a working face mounted to each heater guard plate on the face thereof destined to be remote from the reaction vessel, the Peltier cell having also a base face; and
a temperature reference module contiguous with the base face of each Peltier cell.

68. Apparatus as claimed in claim 12 and incorporating a retainer arranged for clamping the reaction vessel within its station in the apparatus, thus to maintain contiguity between the vessel exterior walls and the heater guard plates.

69. Apparatus as claimed in claim 12 and having a temperature sensor associated with the at least one station.

70. Apparatus as claimed in claim 12 and wherein the guard plates are formed with edges arranged for nestling the reaction vessel such that the reaction chamber is completely surrounded by the guard plates, except at the reaction chamber ceiling and the window thereto.

71. Apparatus as claimed in claim 12 and wherein the guard plates are formed with edges arranged for nestling the Peltier cells.

72. Apparatus as claimed in claim 12 and having an optical array arranged for exciting reaction vessel contents through the vessel windows and for receiving light emitted from the vessel contents.

73. Apparatus as claimed in claim 12 and wherein said peltier cells are square and arranged to be coterminous with or overlapping a reaction vessel.

74. Apparatus as claimed in claim 12 and wherein the temperature reference unit is adapted to be maintained at a constant temperature.

75. Apparatus as claimed in claim 12 and comprising a plurality of said reaction vessel stations, each station being arranged for individual, random control.
